(19) United States
(12) Patent Application Publication
(10) Pub. No.: US 2007/0288195 A1
(43) Pub. Date: Dec. 13, 2007

(54) Long line monitoring and locating system

(76) Inventors: James W. Waite, Los Gatos, CA (US); Kun Li, Cupertino, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/716,298

(22) Filed: Mar. 9, 2007

Related U.S. Application Data
(60) Provisional application No. 60/781,389, filed on Mar. 10, 2006.

(51) Int. Cl. G06F 19/00

(52) U.S. Cl. 702/150; 700/1

(57) ABSTRACT

A system is provided that can monitor concealed lines and can assist in locating the concealed lines. The system includes a management system, a transmitter, a first node, and a second node. The transmitter is configured to communicate with the management system, wherein the transmitter transmits an AC power signal identifying a command and at least one node to assist in executing the command. The first node is configured to receive the AC power signal, to consume the AC power signal, and to source an output signal according to the command by supplying the output signal to a first conductor segment. The second node is configured to receive the AC power signal from the conductor segment and to prepares itself to receive the output signal from the first node according to the command.

### BACKGROUND

1. Field of the Invention

The present invention relates to a line management system, and, in particular, to a concealed line management system that can monitor concealed lines and assist in locating the concealed lines.

2. Discussion of Related Art

Utility lines are often buried underground or concealed in walls and therefore are not readily accessible or identifiable. It is often necessary to monitor these concealed utility lines to determine whether the lines have been damaged. Further, it is often necessary to locate these concealed utility lines to repair and replace them. It is also important to know the location of the utility lines to avoid them while excavating an area. Examples of hidden utility lines include pipelines for gas, sewage, or water and cables for telephone, television, fiber optic, or power.

Underground pipe and cable locators (sometimes termed line locators) have existed for many years and are described in many issued patents and other publications. Line locator systems typically include one or more transmitters connected to a cable conductor (e.g., a sheath) used for detecting the location of the underground pipe or cable. If these cable conductors get damaged in any way, such as during an excavation, the conductor cannot provide an optimal signal to the field technician trying to locate the cable.

Cable conductor conditions can be monitored by measuring the cable conductor's resistance to ground. Traditionally, maintenance technicians measured these conditions using portable-above ground Megger instruments to manually measure the resistance of the cable conductors at test points along the cable route. This manual measuring is very time consuming and labor intensive.

Attempts have been made to provide a system that does not require manual measurement of the resistance of the cable conductor. However, these systems have significant problems resulting from the transmitters providing approximately −48 VDC through the conductors to nodes of a system for purposes of monitoring the conductor's health. Providing DC power through the conductor results in sheath burn-in, which corrodes the sheath and can result in ground faults over time. Furthermore, these nodes require stringent separate signal and power grounds installed at sites having often poor grounding conditions, resulting in signaling problems during operation. Therefore, there is a need for a better system to effectively monitor cable conductors.

### SUMMARY

In accordance with some embodiments of the present invention, a system for monitoring and testing underground concealed conductors is presented. Embodiments of the system can include a management system, a transmitter, a first node, and a second node. The transmitter is configured to communicate with the management system, wherein the transmitter transmits an AC power signal identifying a command and at least one node to assist in executing the command. The first node is configured to receive the AC power signal, to consume the AC power signal, and to source an output signal according to the command by supplying the output signal to a first conductor segment. The second node configured to receive the AC power signal from the conductor segment and to prepare itself to receive the output signal from the first node according to the command.

A method according to some embodiments of the present invention can include receiving, at a node, an AC power signal generated by a transmitter, wherein the AC power signal includes a command and at least one identified node address; determining whether the node's address matches the identified node address; and participating in the command based on the determination.

A node according to some embodiments may include at least one switch; and a processor configured to receive an AC power signal including a command and at least one identified node address, to determine whether the node's address matches the identified node address; to reconfigure the at least one switch based on the determination, and to participate in executing the command. In some embodiments, the node may include a memory configured to provide a downstream node's address to the processor so that the processor can determine whether the downstream node's address matches the identified node address. In some embodiments, the node may include a signal generator. In some embodiments, the generator can be configured to generate a direct current voltage to be provided to a target node when the command is a line monitoring command. In some embodiments, the generator can be configured to generate a line locate signal to be provided to a conductor sheath segment, wherein the conductor segment creates an electromagnetic field when the line locate signal flows through the conductor segment. In some embodiments, the node can include a sensor that detects moisture with the node and provides the moisture data to the processor, which incorporates the moisture data into the health data. In some embodiments, the node can include a sensor that detects the temperature of the node and provides the temperature data to the processor, which incorporates the temperature data into the health data.

These and other embodiments are further discussed below with reference to the following figures.

### BRIEF DESCRIPTION OF THE DRAWINGS

FIG. 1 illustrates a block diagram of a line monitoring system according to some embodiments of the present invention.

FIGS. 2A-B illustrate exemplary graphical charts regarding the communication of a transmitter and its associated nodes and sub-nodes.

FIG. 3 illustrates a block diagram of the internal configuration of an exemplary node according to some embodiments of the present invention.

FIGS. 4A-B illustrate exemplary cable networks.

FIGS. 5A-B illustrate exemplary flowcharts for determining the status of the node after receiving an AC power signal according to some embodiments of the present invention.

In the figures, elements having the same designation have the same or similar functions.

### DESCRIPTION OF THE EMBODIMENTS

Reference will now be made in detail to the exemplary embodiments implemented according to the invention, the examples of which are illustrated in the accompanying drawings.

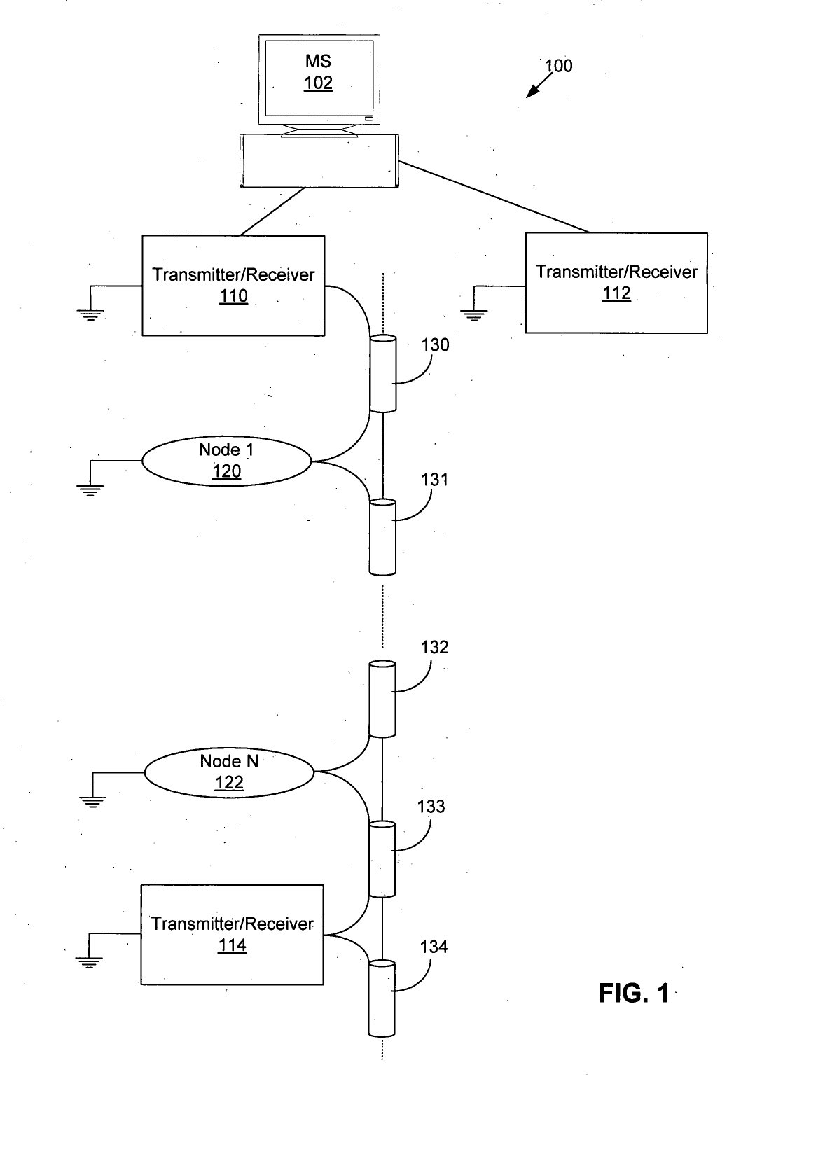

FIG. 1 is a block diagram of an embodiment of a line monitoring system, according to the present invention. Line monitoring system 100 can be any type of system that monitors or locates concealed lines. For example, the system 100 can include a management system 102, one or more transmitter/receivers 110, 112, 114, one or more nodes 120, 122, and one or more cable sheath sections 130-134.

Management system (“MS”) 102 is a hardware and/or software component that provides a user interface to an operator. For example, MS 102 could be the Metrotech Management System. MS 102 allows the operator to monitor the health of line monitoring system 100 and can also assist a field technician in locating the concealed line. For example, MS 102 can determine the health of the line monitoring system 100 by transmitting a signal to transmitter 110, which transmit an AC power signal to one or more nodes 120, 122 that measure, for example, cable sheath resistance to ground. In some embodiments, MS 102 can communicate with transmitter 110 using wireless means. As a result, at least one of the nodes can provide the measurement data to transmitter 110, which provides the measurement data to MS 102. This process can be performed automatically and periodically at the times programmed by the operator. By monitoring sheath resistance, MS 102 can generate alarm conditions for cable cuts and sheath faults via insulation resistance, and AC current and phase changes over time. While a sheath is used throughout this description, it is not limited to being only a sheath and can be expanded to include any conductor. Further, MS 102 can generate alarms for determining if there are moisture or temperature changes in the nodes. Furthermore, MS 102 provides operators with a user interface showing active locate sections, activity history, and monitoring status of the network. Moreover, MS 102 may include a local or remote data storage device that stores measurement data for archival and historical trending analysis.

One or more transmitter/receivers (“transmitter”) 110, 112, 114 are hardware and/or software components that communicate with MS 102 and one or more nodes 120, 122 through sheaths 130-132. For example, transmitters 110, 112, 114 could be Metrotech Orca i6000 transmitters. In some embodiments, the transmitter can be separated into transmitter and receiver components. Transmitters 110, 112, 114 can include a data storage device that stores a list of addressable nodes in its coverage domain. In some embodiments, transmitter 110, 112, 114 can act as a node.

In general, a transmitter can, be coupled to any number of nodes. In some embodiments, transmitter 110, 112, or 114 can connect up to 8 groups of nodes and sub-nodes, wherein each group can include 16 nodes and up to 8 sub-nodes per base node. For each group of nodes and subnodes, transmitter 110, 112, or 114 can have a power amplifier output module to provide a sufficient AC power signal to each node and subnode. After receiving instructions from MS 102, transmitter 110 can generate an AC power signal for transmitting through the one or more sheaths of the network to the-specified node. The frequency of the AC power signal can be any frequency, for example, between 400 and 1000 Hz. This AC power signal can use a binary format identifying, among other things, a message, a signal node address, a target node address, a command, data, cycle redundancy check, etc. The total packet length of the AC power signal can be any length, for example between 8 to 256 bytes. Thus at a 4 bps baud rate, the total transmission time from transmitter to node can range from 16 sec to 512 sec. Depending on the number of nodes in the monitoring system, the transmission time can be multiplied.

Assume a 1-minute measurement time for the following example of a global message from transmitter 110, 112, or 114 requesting an updated insulation resistance measurement (2-bytes) from 16 nodes in the network. For a typical global message requesting an updated insulation resistance measurement (2-bytes) from the 16 nodes in the network, the message is global and passed from down the line to the last node (requiring 16 hops). Thus each node performing the measurement is powered directly from the far end transmitter. At the completion of the measurement at each node, the results are passed back to the upstream node and that segment of sheath is lifted. For example, the total time for this global message could take approximately 34 minutes assuming a 4-bps baud rate. In addition to insulation resistance, if the return message response also includes ground resistance, humidity, temperature, phase, and current magnitude (2-bytes each, for an additional 10-bytes [20 seconds] per node), then the total cycle time for the global message would be approximately 79 minutes.

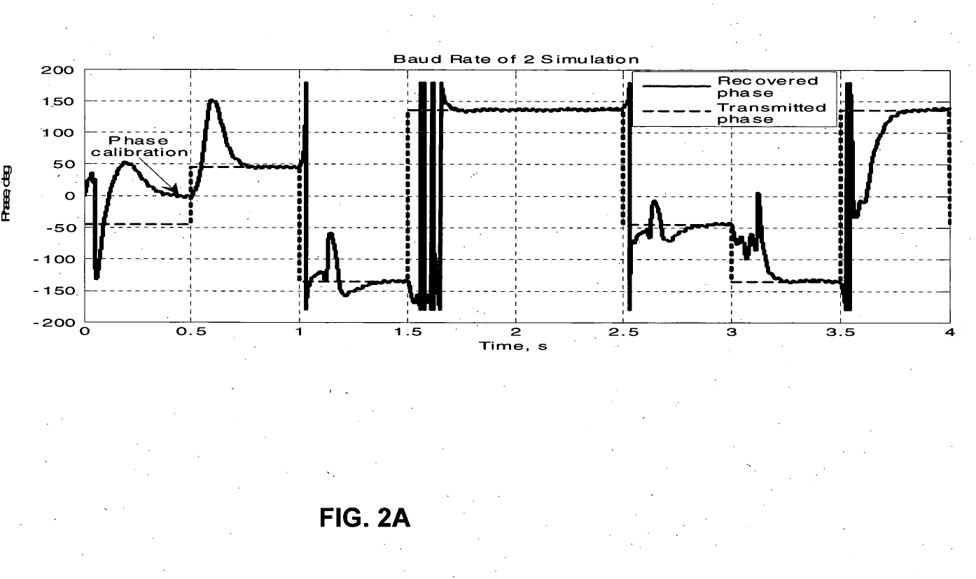

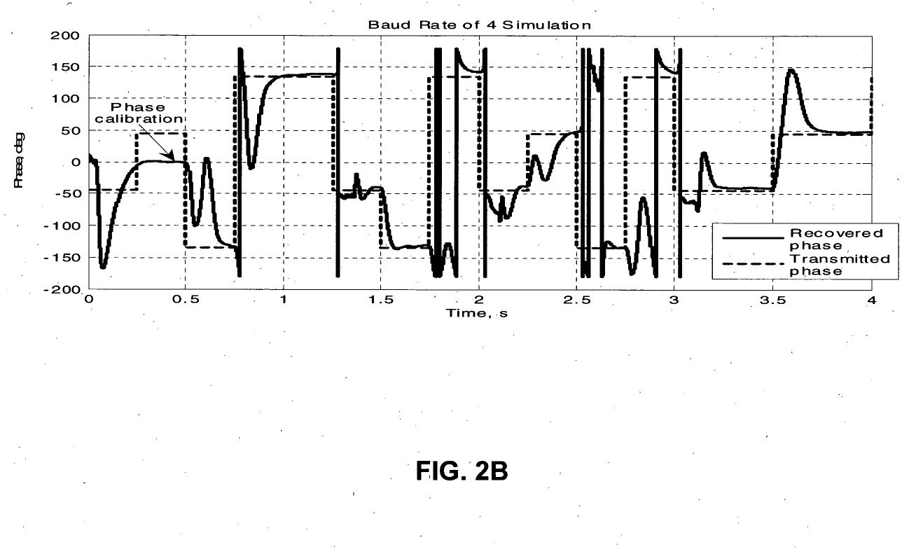

An exemplary transmitter is provided within U.S. application Ser. No. 10/622,376 (now U.S. Pat. No. 7,062,414), titled “Method and Apparatus for Digital Detection Electromagnetic Signal Strength and Signal Direction in Metallic Pipes and Cables,” which is incorporated herein by reference. FIG. 2A illustrates a chart showing that by increasing the bandwidth of the ARM filters in DPLL of the exemplary transmitter, with a 4-QAM signal constellation (00: π/4, 01: −π/4, 10: −3π/4, 11: 3:π/4), a baud rate of 2 symbol/s, identical to 4 bits per second, is achievable. If the FSK modulation frequency of the exemplary transmitter is increased from 30.6875 Hz to 81.8333 Hz, a theoretical baud rate of 4 symbol/s, identical to 8 bits per second, is achievable as shown in FIG. 2B.

Referring back to FIG. 1, Nodes 120, 122 are hardware and/or software components that receive the AC power signal from transmitter 110. Usually, the nodes can be installed at splices or end points in manholes, or customer premises. Each node has a unique address associated with it. If the AC power signal's node address matches the node's address, node 120 can act on the command provided within the AC power signal; otherwise, node 120 can pass the AC power signal to the next node or transmitter for processing. Whether the node's address is identified by the AC power signal or not, node 120 acknowledges the receipt of the signal. The command within the AC power signal can include, among other things, a line locating command, a line monitoring command, or a request for node health data. Further, the node provides additional information in a return AC power signal back to transmitter 10, which provides the information to MS 102 to assist MS 102 in monitoring the line monitoring system 100. For example, this information can include insulation resistance, earth ground resistance, humidity levels within the node, temperature of the node, AC current phase, and AC current magnitude. In some embodiments, this information can be provided in the acknowledgement message.

Sheath sections 130-134 are sheaths that are separated according to their positions between nodes. For example, the sheath sections can include, among other things, one or more optical fibers enclosed by a sheath. Sheaths insulation resistance values typically range from 2 kΩ to 2MΩ. As noted above, while the terms ‘sheath’ and ‘sheath section’ are used throughout the description, these terms are not limiting and any conductor or conductor section can be used.

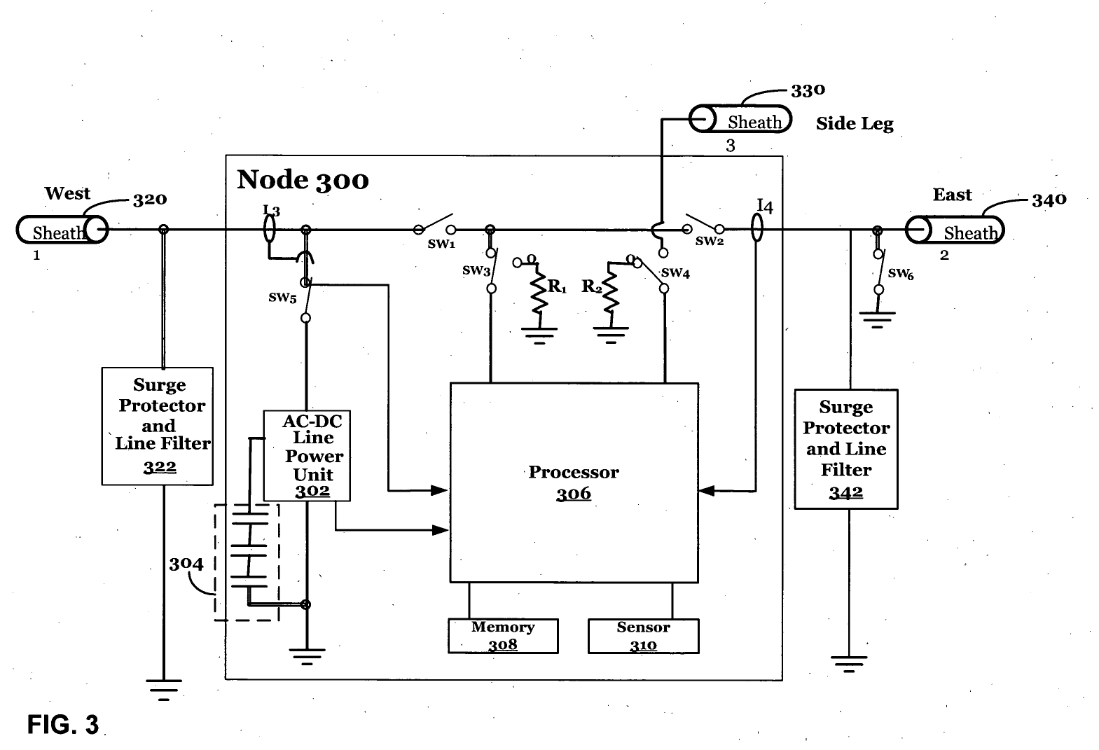

FIG. 3 illustrates a block diagram of the internal configuration of exemplary node 300. Node 300 is similar to nodes 120, 122 depicted in FIG. 1. Further, sheath sections 320, 330, 340 are similar to sheath sections 130-134 depicted in FIG. 1 and each sheath section can include a surge protector and line filter 322, 342. Node 300 may include, among other things, relay switches SW1-6, an AC-DC line power unit 302, a capacitor bank 304, a processor 306, a memory 308, one or more sensors 310, and calibration resistors R1, R2. This embodiment is intended to illustrate communications from the west sheath 320 to the east sheath 340. Additional components, such as another AC-DC line power unit and capacitor bank, may be needed for communication from the east sheath 340 to the west sheath 320 or a side leg sheath 330. Further, this node 300 is only exemplary in nature and is not limited to this configuration.

AC-DC line power unit 302 is a component that rectifies the AC power and steps down the DC power while capacitor bank 304 stores energy and supplies power when requested to do so by processor 306. Depending on whether the AC power signal commands node 300 to perform a line monitoring function or a line location function, power unit 302 provides the appropriate current signal. If node 300 acts as the signal node during a line monitoring function, power unit 302 can provide a DC current through the node to the downstream target node via the east sheath 340. If node 300 acts as the target node during the line; monitoring function, it can provide an AC power signal that provides data regarding the health of the upstream sheath back to the transmitter through west sheath 320.

If node 300 acts as the signal node during the line locate function, power unit 302 can apply an AC power signal at a frequency through the sheath to the downstream node. The frequency of the AC signal applied to the conductor can be referred to as the active locate frequency. By using an AC power signal, the sheath generates an electromagnetic field, which can be detected by a manual line locator. To further assist the line locator to locate the sheath, the electromagnetic field generated can be phase corrected (i.e., the phase reference is adjusted to zero, compensating for any phase offsets that have accumulated as the signal has propagated down the line from the point of transmission). Per the methods discussed in U.S. application Ser. No. 11/100,696, this allows the line locator to further pinpoint a specific underground line without a phase bias. For example, the phase corrected signal can be identified as a signal select modulated signal in the appropriate line location receiver, such as the Metrotech i5000 line locator. In some embodiments, this electromagnetic field can be further described in application Ser. No. 10/622,376 (now U.S. Pat. No. 7,062,414), titled “Method and Apparatus for Digital Detection Electromagnetic Signal Strength and Signal Direction in Metallic Pipes and Cables”; application Ser. No. 10/842,239 (now U.S. Pat. No. 7,057,383), titled “Method for Decoupling Interference due to Bleedover in Metallic Pipe and Cable Locators”; application Ser. No. 11/100,696, titled “Precise Location of Buried Metallic Pipes and Cables in the Presence of Signal Distortion”; and application Ser. No. 10/997,124 (now U.S. Pat. No. 7,113,124), titled “Sensor Fusion for Model-Based Detection in Pipe and Cable Locator Systems,” each of which are incorporated herein in their entirety.

In some embodiments, by using signal select, the power unit 302 provides a zero phase signal to be sent through the downstream sheath. Any arbitrary reference phase may be chosen by convention between the transmitter and receiver, facilitating the line locator to help distinguish this cable line from other cable lines. This signal select modulation method transmits power focused in a narrow frequency band. It further uses a simple 4-QAM bit constellation derived from a FSK/PSK modulation format for data communications and allows ground-level line locate operations to take place while monitoring is still in progress. The communication can be a half-duplex (one direction at time) providing flexible asynchronous timing specification where a separate serial clock is not required. The communication can also facilitate reliable communication for long distances by using a low 4-bps baud rate at nominal AC frequencies, such as 400-1000 Hz.

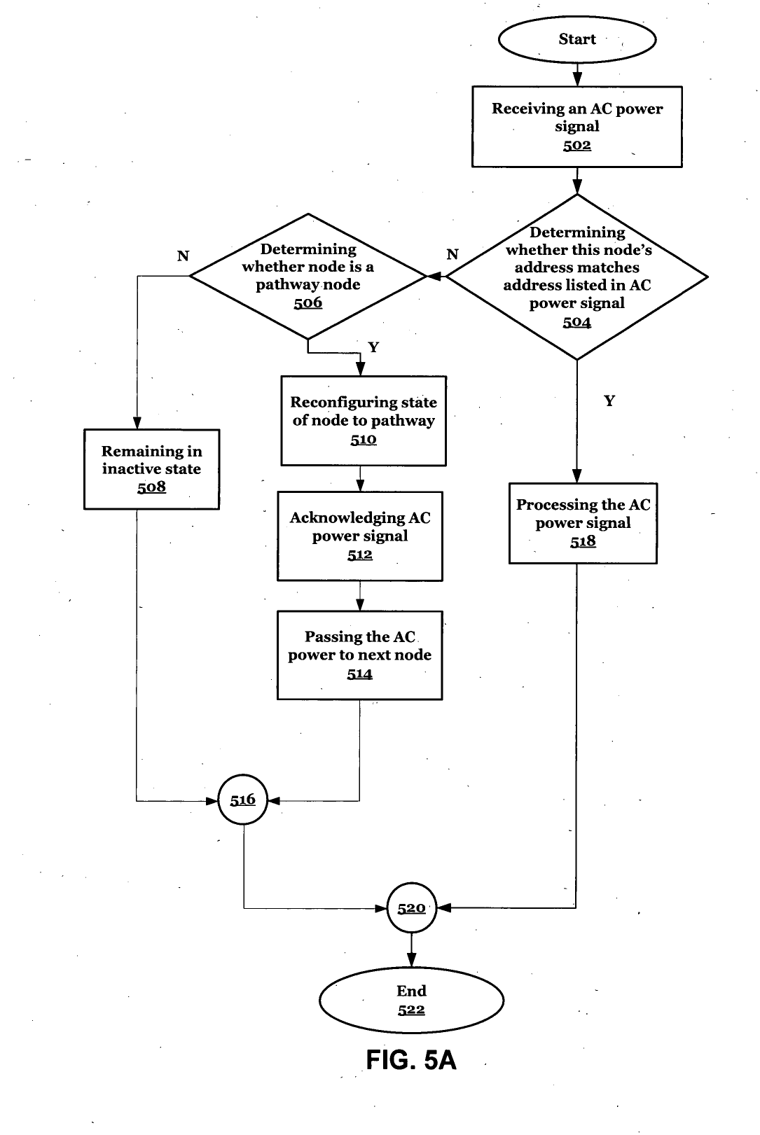

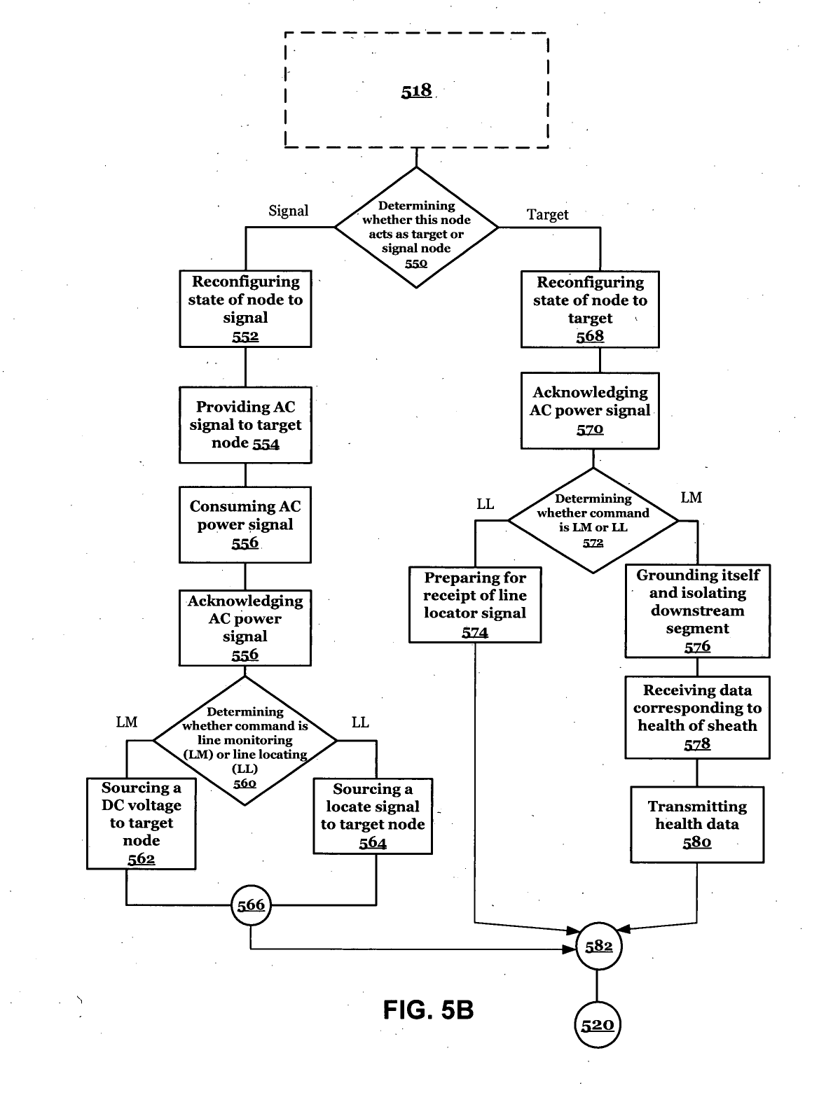

Processor 306 receives the AC power signal and processes the signal accordingly. In some embodiments, processor 306 is a digital signal processor. When the processor is a digital signal processor, the node can include, among other things, an analog-to-digital converter so that it can receive communication from the transmitter, and a digital-to-analog converter that can transmit signals to an amplifier (not shown). For example, the transmitted data can include any data, such as acknowledgement data or health data. Processor 306 communicates with memory 314, one or more sensors 316, and relay switches SW1-6. Functionality of processor can be further described in FIGS. 5A-B.

Memory 308 is a data storage device that stores data for node 300. Memory 308 can store, among other things, data regarding downstream nodes' addresses. For example, when processor 306 receives an AC power signal, which designates the signal and target nodes, processor 306 has the ability to determine if it is a pathway to the downstream nodes or an inactive node not located in the pathway. Processor 306 can determine whether it should be a pathway node or an inactive node by accessing the downstream node data in the memory 308. If there is a match between at least one of the designated nodes with the downstream nodes data in the memory, node 300 can then configure itself to be a pathway node; otherwise, it can be an inactive node.

Sensor 310 has the ability to derive relevant data of node 300 and provide the relevant data to the processor 306 for reporting the relevant data to the transmitter. For example, the relevant data can include, among other things, temperature and moisture data sensed within node 300.

Relay switches SW1-6 are used to configure at least four states according to the node's role. After receiving the AC power signal from the transmitter, the processor 306 can reconfigure its state by adjusting the switch settings. These states may include, among other things, pathway, signal, target, and inactive. The following table describes the switch configuration according to the state of the nodes:

TABLE 1
Node Switch Settings

| State of Node | SW1 | SW2 | SW3 | SW4* | SW5 | SW6 |
|---|---|---|---|---|---|---|
| Pathway | Closed | Closed | Open | Open | Open | Open |
| Signal | Open | Closed | Closed | Open | Closed | Open |
| Target | Closed | Open | Closed | Open | Closed | Open |
| Inactive | Open | Open | Open | Open | Open | Open |

*Assume transmission takes place from West to East
*Ignore the sheath on the side leg in this analysis

As a pathway node, node 300 can pass the AC power signal from input to output directly. As a signal node, node 300 would act as a local transmitter by outputting a signal through the downstream sheath while absorbing power from an upstream transmitter. If acting as a target node during a line locating command, node 300 would sink current and AC power from the upstream signal node. If acting as a target node during a line monitoring mode, node 300 would consume AC power directly from the transmitter. If node 300 is inactive, then there is no current in or out because this node is not located on the path for any active locate or monitor.

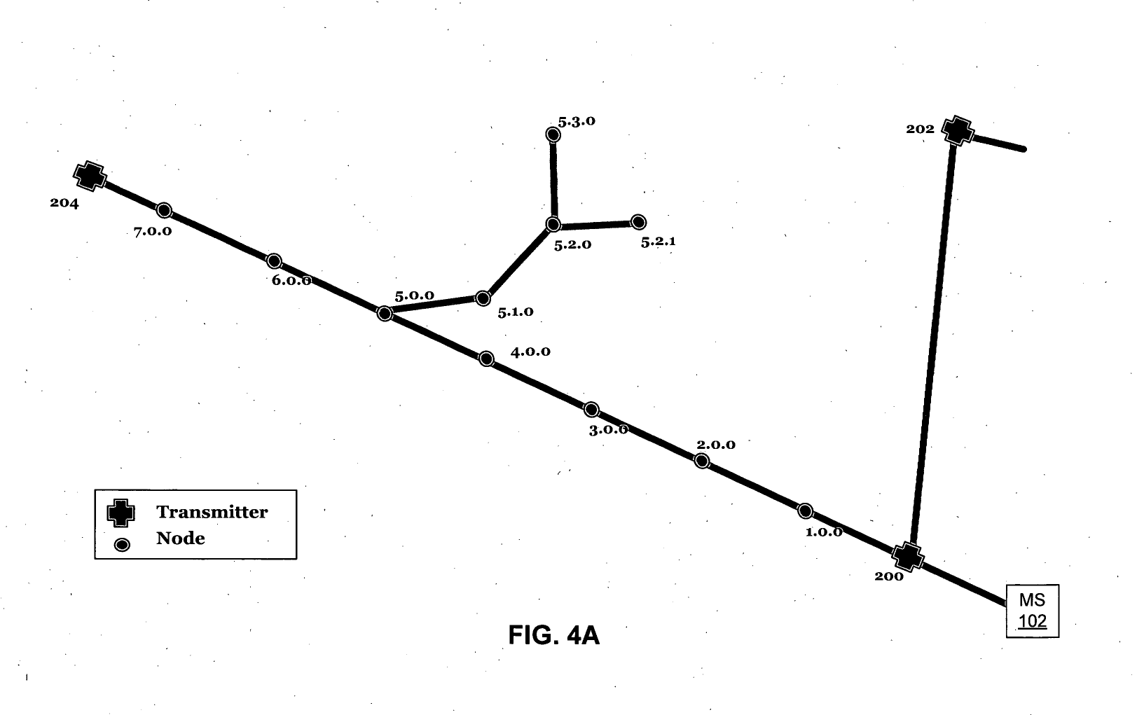

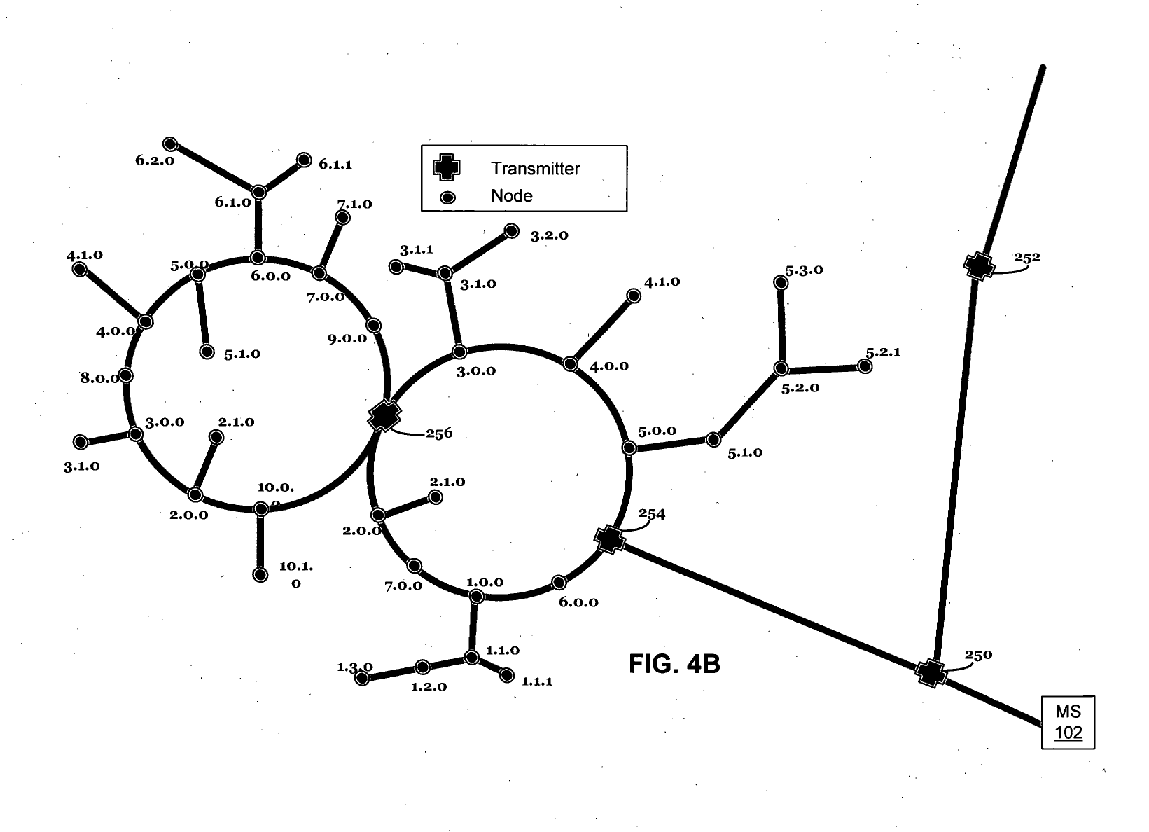

FIGS. 4A-B illustrate exemplary cable networks. In FIG. 4A, the exemplary cable network is a long-haul cable network including MS 102, transmitters 200, 202, 204, and several addressed nodes (e.g., node 5.3.0 or node 4.0.0). In this particular embodiment, while the network is described according to line monitoring event, this network is not limited to only monitoring the health of the line and can perform other events, such as assisting in line locating. For example, MS 102 can send a signal to transmitter 200 requesting transmitter 200 to assist in determining the insulation resistance of the cable sheath between nodes 2.0.0 and 3.0.0. To assist in monitoring, transmitter 200 generates an AC power signal. After generating an AC power signal, transmitter 200 transmits the signal through the entire cable network. Each node is inactive until it receives the AC power signal and determines its status. The status can include the node remaining inactive or switching its status to a pathway node, signal node, or target node. For example, the AC power signal can designate node 2.0.0 as the signal node and node 3.0.0 as the target node in the message. In some embodiments, the message can identify only a target node where the neighboring upstream node is programmed to act as a signal node when it detects that a downstream node is the target. In some embodiments, the message can identify only a signal node where a downstream node is programmed to act as a target node when it detects that the upstream node is the signal node. While usually there is a 1-6 km distance between the nodes, the distance can be any length.

After generating an AC power signal, transmitter 200 transmits the signal to node 1.0.0. Node 1.0.0 determines whether it is the intended target node. In this particular example, node 1.0.0 determines that the specified address in the AC power signal does not match its node address. Node 1.0.0 further determines whether its downstream nodes match the node address provided in the message. In this case, nodes 2.0.0 and 3.0.0 are downstream and node 1.0.0 configures itself to be a pathway node and transmits an acknowledgement message to the transmitter that it is acting as a pathway node. By acting as a pathway node, node 1.0.0 passes the AC power signal to node 2.0.0.

After receiving the AC power signal, node 2.0.0 determines that the signal node provided in the AC power signal's message matches its address and that the command requests a line monitoring event. Node 2.0.0 begins consuming the AC power signal and acknowledges the signal by sending an acknowledgement message back to transmitter 200. Node 2.0.0 consumes the AC power signal from transmitter 200 to source the signal to be transmitted through the downstream sheath. Because this is a line monitoring event, node 2.0.0 converts the AC power signal into a DC voltage to be transmitted through the downstream sheath. By transmitting a DC voltage through the downstream sheath, the target node can determine the insulation resistance of cable sheath between nodes 2.0.0 and 3.0.0.

Node 3.0.0 receives the AC power signal from transmitter through nodes 1.0.0 and 2.0.0. After receiving the AC power signal, node 3.0.0 determines that it is a target node after matching the target node's address within the AC power signal's message and its own address. Once it identifies itself as the target node, node 3.0.0 transmits an acknowledgement message back to transmitter, grounds itself, and disconnects itself from the sheath between it and node 4.0.0. At some point after the disconnection of 3.0.0's downstream sheath, node 2.0.0 applies a DC voltage (e.g., 100 VDC) across the downstream sheath for a period of time (e.g., 1 minute) between it and node 3.0.0 so that node 3.0.0 can measure the health data (e.g., insulation resistance) of the sheath between nodes 2.0.0 and 3.0.0. After node 3.0.0 updates the health data, transmitter 200 can send a request to node 3.0.0 before it returns the health data. In some embodiments, after receiving a request from transmitter 200, node 3.0.0 can send this health data to node 2.0.0. Transmitter 200 would then request this health data from node 2.0.0, which would transmit the monitored sheath's health data to node 1.0.0, which would provide the health data to transmitter 200 when requested to do so. In some embodiments, node 3.0.0 can provide the health data to transmitter 200 automatically. Once it receives the health data, transmitter 200 would provide this health data to MS for processing.

In FIG. 4B, the exemplary cable network is an urban ring cable network including MS 102, transmitters 250, 252, 254, 256 and several addressed nodes (e.g., node 5.3.0 or node 4.0.0). In this particular embodiment, while the network is described according to line locating events, this network is not limited to only assisting in locating lines and can perform other events, such as monitoring the health of the nodes and cable sheaths. For example, an MS can send a signal to transmitter 254 requesting it to assist in locating the cable line between nodes 1.0.0 and 1.1.0. To assist in locating, transmitter generates an AC power signal. After generating an AC power signal, transmitter 254 transmits the signal through the entire cable network. Each node is inactive until it receives the AC power signal and determines its status. The status can include the node remaining inactive or switching its status to a pathway node, signal node, or target node. For example, the AC power signal designates node 1.0.0 as the signal node and node 1.1.0 as the target node in the message.

Node 6.0.0, the node between transmitter 254 and node 1.0.0, determines its status so that it can perform its role. In this particular example, node 6.0.0 determines not only that the specified addresses in the AC power signal do not match its node address but also that these specified addresses are located downstream. Because the specified nodes are located downstream, node 6.0.0 determines that it is a pathway node and passes the AC power signal to signal node 1.0.0 and target node 1.1.0. After receiving the AC power signal, nodes 1.0.0 and 1.1.0 determine their statuses as the signal node and the target node, respectively. In some embodiments, signal node 1.0.0 and target node 1.1.0 can acknowledge their status by sending an acknowledgment message back to transmitter 254 so that transmitter 254 can cut the AC power signal being sent out. This exemplary embodiment is not limited to only locating sheaths between directly neighboring nodes. For example, node 5.0.0 can act as the signal node while node 5.2.0 acts as the target node. This allows a field technician with a line locator to locate the concealed line between nodes 5.0.0 and 5.2.0. Further, transmitter 254 can act as a signal, pathway, or a target node as well.

After receiving the AC power signal, node 1.0.0 determines that the signal node address provided in the AC power signal's message matches its address and that the command requests a line locating event. Node 1.0.0 also provides the AC power signal to the target node (such as node 1.1.0). Node 1.0.0 begins consuming the AC power signal and acknowledges the signal by sending an acknowledgement message back to transmitter 200. Node 1.0.0 consumes the AC power signal from transmitter 254 to source the AC locate signal to be transmitted through the downstream sheath. For example, signal node 1.0.0 can generate a signal according to the signal select modulation method. By transmitting the AC locate signal through the downstream sheath, an electromagnetic field is created allowing a line locator to properly identify the signal. For example, this electromagnetic field can be phase corrected to further assist the line locator's line identification process.

Programming node 1.0.0 to act as a transmitter for sourcing a locate signal for the downstream cable sections has several advantages. For example, in a 16 node system, the worst-case setup time in some embodiments for this operation is 256 seconds (16 nodes*16 seconds). Further, in long-haul cable deployments, local sourcing of the cable locate tone has the advantage that the phase of the phase corrected local signal is tracked to zero, which enables distortion detection and precise cable locations via walkover optimization methods.

Node 1.1.0 receives the AC power signal from transmitter through nodes 6.0.0 and 1.0.0. After receiving the AC power signal, node 1.1.0 determines that it is a target node after matching the target node's address within the AC power signal's message and its own address. Once it identifies itself as the target node, node 1.1.0 transmits an acknowledgement message back to transmitter 254 and disconnects itself from the sheaths between it and nodes 1.1.1 and 1.2.0. At some point after the disconnection of the downstream sheaths, signal node 1.0.0 applies an AC voltage to target node 1.1.0, via the conducting sheath, which generates the electromagnetic field for line locating purposes. In some embodiments, the electromagnetic field can provide a phase corrected locate signal. Using a line locator that can locate the phase corrected locate signal, a field technician has a better ability to locate the concealed line.

FIGS. 5A-B illustrate exemplary flowcharts for processing an AC power signal according to the status of a node. Regarding FIG. 5A, it will be readily appreciated by one of ordinary skill in the art that the illustrated procedure can be altered to delete steps or further include additional steps. After initial start step 500, the node receives an AC power signal in step 502, which may provide, among other things, address data for the signal node, address data for the target node, command data, other data identified above in the text corresponding to FIG. 1, or any other relevant data. The AC power signal could be received directly from a transmitter or indirectly from the transmitter through an upstream node. In some embodiments, the transmitter provides an AC power signal having 400-1000 Hz frequency but it is not limited to this frequency. In some embodiments, the receiving node may also be a transmitter.

After receiving the AC power signal, in step 504 the node determines whether its address matches one of the AC power signal's addresses: the signal node address or the target node address. If a match does not occur, in step 506 the node further determines whether the node is a pathway node. In some embodiments, one way to determine this is for the node to access its memory to determine if one or both of the addresses identified in the AC power signal is a downstream node address. If the node is not a pathway node, the node remains in the inactive state in step 508; and the flowchart proceeds to connector 516 and then to connector 520. If the signal identifies a downstream node, in step 510, the node can reconfigure its state from the inactive state to the pathway state and acknowledge the receipt of the AC power signal in step 512. After reconfiguring its state, the node then passes the AC power signal to the next node in step 514 and the flowchart proceeds to end 522.

Referring back to the determination step 504, if one of the node addresses identified in the AC power signal matches this node's address, the node processes the AC power signal in step 518. An exemplary processing is. described below in FIG. 5B. After the processing of the AC power signal, the message proceeds to end at step 522.

Regarding FIG. 5B, it will be readily appreciated by one of ordinary skill in the art that the illustrated procedure can be altered to delete steps or further include additional steps. To begin processing the AC power signal, the node determines whether this node acts as the target node or the signal node in step 550 by checking the AC power signal. If the node is a signal node, the node reconfigures its state to a signal node in step 552 and provides the AC power signal in step 554 to the target node so that it can change its state as well. After reconfiguring its state, the node consumes the AC power signal in step 556 so that it can generate a signal to a target node. Further, after the signal node has consumed the AC power signal, the node acknowledges receipt of the AC power signal in step 558 so that the transmitter can cut the transmission of the AC power signal. In some embodiments, the consuming and acknowledging steps 556, 558 can be switched.

Next, the signal node determines whether the command in the AC power signal requested a line monitoring (LM) or a line locating (LL) event in step 560. In some embodiments, determination step 560 can be performed at any prior point on this flowchart. If the event is a line monitoring event, the node can source a DC voltage (e.g., 100 VDC) to the target node in step 562. The sourcing can occur by generating a DC voltage from the consumed AC power signal and providing the DC voltage to the target node through a sheath segment. By doing so, the signal node can segregate the cable sheath segment from the other cable sheaths for determining the health of the particular sheath. After sourcing the voltage, the flowchart can proceed to connector 520 in FIG. 5A.

On the other hand, if the command requests a line locating event, the node sources a line locate signal to the target node in step 564. In some embodiments, this line locate signal can be an AC signal transmitted through the sheath of the concealed line, wherein the AC signal and the sheath create a line locate electromagnetic signal. In some embodiments, this line locate electromagnetic signal can be phase corrected to better assist a field technician in locating the concealed line. As noted earlier, this phase corrected line locate signal can be the select signal identified above in FIG. 3. After sourcing the line locate signal, the node can proceed to connector 520 in FIG. 5A.

Referring back to determination step 550, if the node's address matches the target node's address specified in the AC power signal, the node reconfigures its state to being a target node in step 568 and acknowledges receipt of the AC power signal in step 570 so that the transmitter can cut the transmission of the AC power signal. After acknowledging receipt, the node determines whether the command in the AC power signal requested a line monitoring (LM) or a line locating (LL) event in step 572. In some embodiments, determination step 572 can be performed at any prior point on the flowchart. If the command requests a line locating (LL) event, the node can prepare for receipt of the line locating signal from the signal node in step 574. After receiving the line locating signal, the flowchart can proceed to connector 520 in FIG. 5A.

On the other hand, when the command within the AC power signal requests the line monitoring (LM) event, the node grounds itself and isolates the downstream sheath segment in step 576 so that the DC voltage signal from the signal node does not leak into the downstream sheath segment. After the isolating step 576, the node receives the DC signal from the signal node in step 578. In some embodiments, the signal node provides a 100 DC voltage signal for approximately 1 minute. This allows the target node to collect data regarding the health of the sheath segment. For example, the health data can include, among other things, sheath insulation resistance. This collected information can assist an MS in determining whether the sheath is damaged so that the operator at the MS can notify field technicians to fix the sheath. After collecting the data, the node transmits the health data to the transmitter in step 580. In some embodiments, the target node includes its temperature and moisture data in the health data so that the MS can monitor the health of the nodes as well. In some embodiments, the node waits for a health data request from the transmitter. Once it receives the health data request, the node can transmit the health data to an upstream node, which will wait for a subsequent request from the transmitter, or the transmitter itself. In some embodiments, the node transmits the health data automatically to the transmitter, which can send the health data to MS. After transmitting the health data, the flowchart proceeds to connector 582, and then to connector 520 in FIG. 5A.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system comprising:
a management system;
a transmitter configured to communicate with the management system, wherein the transmitter transmits an AC power signal identifying a command and at least one node to assist in executing the command;
a first node configured to receive the AC power signal, to consume the AC power signal, and to source an output signal according to the command by supplying the output signal to a first conductor segment; and
a second node configured to receive the AC power signal from the conductor segment and to prepares itself to receive the output signal from the first node according to the command.

2. The system of claim 1, wherein the first node sources a line locate signal through the conductor to the second node when the command is a line locating command.

3. The system of claim 2, wherein the line locate signal is an AC signal that generates an electromagnetic phase corrected line locate signal.

4. The system of claim 1, wherein the first node sources a line monitoring signal through the conductor to the second node when the command is a line monitoring command.

5. The system of claim 4, wherein the line monitoring signal is a voltage direct current signal.

6. The system of claim 4, wherein the second node grounds itself and isolates the conductor segment between the second node and a downstream node, receives line monitoring signal from the first node, updates health data of the conductor segment, and transmits the health data to the transmitter.

7. The system of claim 6, wherein the transmitter transmits the health data to the management device for processing.

8. The system of claim 6, wherein health data includes the second node's health data.

9. The system of claim 1, further comprising a third node that determines whether at least one of the first node or the second node is downstream and provides the AC power signal to at least one of the first node or the second node if they are downstream.

10. The system of claim 1, wherein the transmitter includes the first node.

11. A method comprising:
receiving, at a node, an AC power signal generated by a transmitter, wherein the AC power signal includes a command and at least one identified node address;
determining whether the node's address matches the identified node address; and
participating in the command based on the determination.

12. The method of claim 11, further comprising determining whether the node is a pathway node when the node's address does not match the identified node address.

13. The method of claim 12, further comprising reconfiguring the node to be a pathway node when the node is a pathway node, and providing the AC power signal to the next downstream node.

14. The method of claim of claim 11 determining whether the node is a target or a signal node when the node's address matches the identified node address.

15. The method of claim 14, further comprising reconfiguring the node to be a target node.

16. The method of claim 14, further comprising reconfiguring the node to be a signal node, providing AC power signal to a target node, and consuming the AC power signal.

17. The method of claim 11, further comprising determining the command of the AC power signal when the node is a target node, wherein the command is a line locating command or a line monitoring command.

18. The method of claim 17, wherein the participating includes preparing for receipt of a line locate signal when the command is a line locating command.

19. The method of claim 17, wherein the participating includes grounding the node, isolating a downstream conductor segment, updating data corresponding to the health of the upstream conductor segment when the command is a line monitoring command, and transmitting health data to an upstream component.

20. The method of claim 11, further comprising determining the command of the AC power signal when the node is a signal node, wherein the command is a line locating command or a line monitoring command.

21. The method of claim 20, wherein the participating includes sourcing a direct current voltage through a conductor segment to a target node when the command is a line monitoring command, wherein the target node collects health data of the conductor segment.

22. The method of claim 20, wherein the participating includes sourcing a line locate signal through a conductor segment to a target node when the command is a line locating command, wherein the conductor segment creates an electromagnetic field when the line locate signal flows through the conductor segment.

23. A node comprising:
at least one switch; and
a processor configured to receive an AC power signal including a command and at least one identified node address, to determine whether the node's address matches the identified node address; to reconfigure the at least one switch based on the determination, and to participate in executing the command.

24. The node of claim 23, further comprising a memory configured to provide a downstream node's address to the processor so that the processor can determine whether the downstream node's address matches the identified node address.

25. The node of claim 24, wherein the processor reconfigures the at least one switch so that the node acts as a pathway node when the downstream node's address matches the identified node address.

26. The node of claim 23, wherein the processor reconfigures the at least one switch so that the node acts as a signal node based on the determination.

27. The node of claim 23, wherein the processor determines whether the command is a line locating command or a line monitoring command based on the match determination.

28. The node of claim 27, further comprising a signal generator that generates a direct current voltage to be provided to a target node when the command is a line monitoring command.

29. The node of claim 27, further comprising a signal generator that generates a line locate signal to be provided to a conductor sheath segment, wherein the conductor segment creates an electromagnetic field when the line locate signal flows through the conductor segment.

30. The node of claim 23, wherein the processor reconfigures the at least one switch so that the node acts as a target node based on the determination.

31. The node of claim 23, wherein the processor determines whether the command is a line locating command or a line monitoring command based on the match determination.

32. The node of claim 31, wherein the processor participates in executing the line locating command by preparing for receipt of a line locate signal.

33. The node of claim 31, wherein the processor participates in executing the line monitoring command by grounding itself, isolating a downstream conductor segment, updating data corresponding to the health of the upstream conductor segment, and transmitting health data to an upstream component.

34. The node of claim 33, further comprising a sensor that detects moisture with the node and provides the moisture data to the processor, which incorporates the moisture data into the health data.

35. The node of claim 33, further comprising a sensor that detects the temperature of the node and provides the temperature data to the processor, which incorporates the temperature data into the health data.
